(19) United States
(12) Patent Application Publication
(10) Pub. No.: US 2014/0337698 A1
(43) Pub. Date: Nov. 13, 2014

(54) METHOD, APPARATUS AND MOBILE TERMINAL FOR SELECTING HYPERLINKS

(71) Applicant: Tencent Technology (Shenzhen) Company Limited, Shenzhen City (CN)

(72) Inventors: Zhipei WANG, Shenzhen City (CN); Huijiao YANG, Shenzhen City (CN); Bo HU, Shenzhen City (CN); Kai ZHANG, Shenzhen City (CN); Bosen HE, Shenzhen City (CN); Ying HUANG, Shenzhen City (CN); Yulei LIU, Shenzhen City (CN); Wei LI, Shenzhen City (CN); Cheng FENG, Shenzhen City (CN); Xi WANG, Shenzhen City (CN); Zhengkai XIE, Shenzhen City (CN); Ruiyi ZHOU, Shenzhen City (CN); Xin QING, Shenzhen City (CN)

(21) Appl. No.: 14/340,796

(22) Filed: Jul. 25, 2014

Related U.S. Application Data
(63) Continuation of application No. PCT/CN2013/090540, filed on Dec. 26, 2013.

(30) Foreign Application Priority Data
Apr. 24, 2013 (CN) 201310144230.0

(51) Int. Cl. G06F 17/22; G06F 3/0484

(52) U.S. Cl. CPC G06F 17/2235; G06F 3/04842
USPC 715/205

(57) ABSTRACT

The invention can be applied to a field of mobile terminal and provides a method, apparatus and mobile terminal for selecting hyperlinks. The method can include the steps of: detecting a hyperlink selection instruction on a current page; obtaining all hyperlinks within a display region corresponding to the hyperlink selection instruction as candidate hyperlinks, if detecting the hyperlink selection instruction; rendering a new page frame on the current page, the page frame showing the candidate hyperlinks in a preset display ratio; and selecting a required hyperlink from the candidate hyperlinks on the page frame. The invention enables to select a hyperlink on a page more accurately and conveniently.

### CROSS-REFERENCE TO RELATED APPLICATIONS

This application is a U.S. continuation application of International Application PCT/CN2013/090540, with an international filing date of Dec. 26, 2013, claiming the priority benefit of Chinese Patent Application No. 201310144230.0 filed on Apr. 24, 2013, the contents of which are both incorporated by reference herein in their entireties for all intended purposes.

### FIELD OF THE INVENTION

The invention relates to a field of mobile terminal, and in particular, to a method, apparatus and mobile terminal for selecting hyperlinks.

### BACKGROUND

As a mobile phone becomes one of important tools for connecting to a network by a user, due to aspects such as the interface size limitation of a mobile phone and the page layout, the user often encounters a problem of selecting difficultly an object such as a hyperlink or a text typing filed in a webpage on the mobile phone when the user surfs on a network by using the mobile phone. Especially, in a novel reading page, since hyperlinks on a chapter page are small and intensive and have narrow spaces, the user often clicks mistakenly on other undesired chapters or page numbers when making a selection.

An existing browser has a function “zooming in a typing field”. When a user makes an editing operation in the typing field, the user can select the “zooming in a typing field” function and make an editing operation in an interface of a newly popped-up typing field. It is more convenient and accurate for such a zoomed-in typing field to edit a long text. However, certain pages having hyperlinks, especially the novel reading pages, still have the problems that it is difficult to select a hyperlink and the accuracy thereof is low.

### SUMMARY OF THE INVENTION

The present invention provides a method, apparatus and mobile terminal for selecting hyperlinks, which is capable to solve the problems that it is difficult to select a hyperlink and the accuracy thereof is low in a webpage of a mobile terminal.

In one aspect, a method for selecting hyperlinks is provided, the method including the steps of:

detecting a hyperlink selection instruction on a current page;

obtaining all hyperlinks within a display region corresponding to the hyperlink selection instruction as candidate hyperlinks, if detecting the hyperlink selection instruction;

rendering a new page frame on the current page, the page frame showing the candidate hyperlinks in a preset display ratio; and

selecting a required hyperlink from the candidate hyperlinks on the page frame.

In another aspect, an apparatus for selecting hyperlinks is provided, the apparatus including:

an instruction detecting unit configured to detect a hyperlink selection instruction on a current page.

a hyperlink obtaining unit configured to obtain all hyperlinks within a display region corresponding to the hyperlink selection instruction as candidate hyperlinks, if detecting the hyperlink selection instruction;

a hyperlink showing unit configured to render a new page frame on the current page, the page frame showing the candidate hyperlinks in a preset display ratio; and

a hyperlink selecting unit configured to select a required hyperlink from the candidate hyperlinks on the page frame.

In a yet another aspect, a mobile terminal is provided, the mobile terminal including the apparatus for selecting hyperlinks as described above.

In a yet another aspect, a computer readable storage medium storing the computer executable instructions is provided. When executed, the computer executable instructions cause a processor to perform the operations of:

detecting a hyperlink selection instruction on a current page;

obtaining all hyperlinks within a display region corresponding to the hyperlink selection instruction as candidate hyperlinks, if detecting the hyperlink selection instruction;

rendering a new page frame on the current page, the page frame showing the candidate hyperlinks in a preset display ratio; and

selecting a required hyperlink from the candidate hyperlinks on the page frame.

According to embodiments of the invention, a hyperlink selection instruction on a current page is detected. All hyperlinks within a display region corresponding to the hyperlink selection instruction are obtained as candidate hyperlinks, if the hyperlink selection instruction is detected. Anew page frame is rendered on the current page, the page frame showing the candidate hyperlinks in a preset display ratio. A required hyperlink is selected from the candidate hyperlinks on the page frame. The invention enables to select a hyperlink on a mobile terminal more accurately and conveniently.

### DESCRIPTION OF THE DRAWINGS

FIG. 1 is an exemplary implementing flow diagram of a method for selecting a hyperlink provided in a first embodiment of the invention; and

FIG. 2 is an exemplary structural diagram of an apparatus for selecting a hyperlink provided in a second embodiment of the invention.

### DETAILED DESCRIPTION

To make the objects, the technical solutions and the advantages of the invention clearer, the invention will be described in detail in combination with drawings and embodiments. It should be understood that, the specific embodiments described herein are merely for explaining the invention without any limitations.

In various embodiments of the invention, detecting a hyperlink selection instruction on a current page; obtaining all hyperlinks within a display region corresponding to the hyperlink selection instruction as candidate hyperlinks, if detecting the hyperlink selection instruction; rendering a new page frame on the current page, the page frame showing the candidate hyperlinks in a preset display ratio; and selecting a required hyperlink from the candidate hyperlinks on the page frame.

The implementation of the invention will be described in detail in combination with specific embodiments.

### First Embodiment

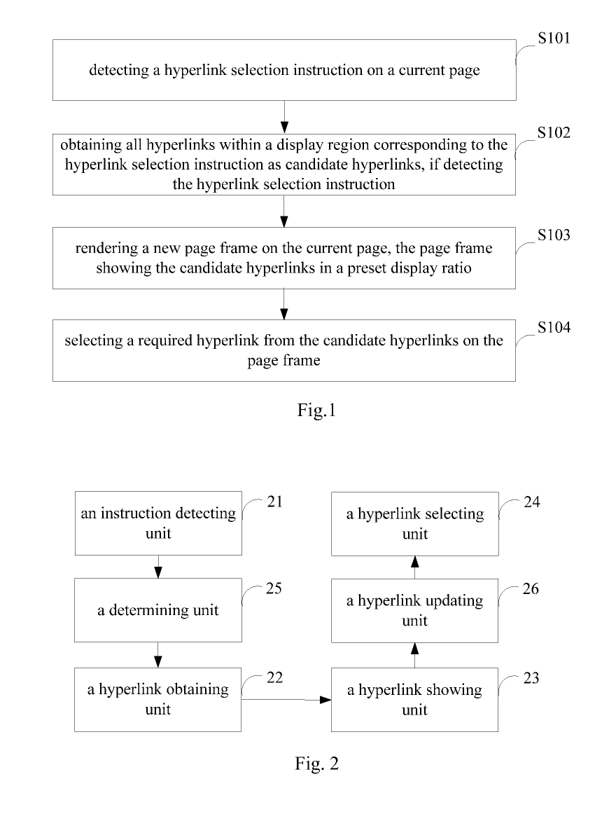

FIG. 1 shows an exemplary implementing flow diagram of a method for selecting a hyperlink provided in a first embodiment of the invention, which will be described in detail as follows.

It should be noted that, a hyperlink is a part of a webpage in essential and is a type of element which allows connections with other web pages or sites. Various webpage links get together to form a website really. A so-called hyperlink means a connecting relation which points from a webpage to a target. The target may be another webpage, a different location on the same webpage, a picture, an email address, a file, or even an application program, for example. An object to be hyperlinked to in a webpage may be a piece of text or a picture. When a viewer clicks a hyperlinked text or picture, a linking object will be displayed on a browser and will open or be executed based on the type of a target.

In step S101, a hyperlink selection instruction on a current page is detected.

In the present embodiment, the hyper link may include text link, image link, page link, e-mail link, anchor link, multimedia link, and application program link. The hyperlink selection instruction is an instruction received by a mobile terminal for selecting a hyperlink by a user, and is triggered by a selection operation of the user. The selection operation includes, but not limited to, a long sliding operation, a long pressing operation, a clicking operation on a display region of hyperlinks. The mobile terminal detects the hyperlink selection instruction on the current page.

In step S102, all hyperlinks within a display region corresponding to the hyperlink selection instruction are obtained as candidate hyperlinks, if the hyperlink selection instruction is detected.

In the present embodiment, the display region is a fixed display region centered on a coordinate point corresponding to the selection instruction. In particular, obtaining, by the mobile terminal, all hyperlinks within a display region corresponding to the hyperlink selection instruction as candidate hyperlinks includes:

obtaining all hyperlinks within a fixed display region centered on a coordinate point corresponding to the selection instruction as the candidate hyperlinks.

Preferably, the display region can be obtained according to aspects such as the size of preset display ratio and the selection accuracy, and then the mobile terminal can obtain one or more hyperlinks within the display region as the candidate hyperlinks.

Alternatively, before the step S102, it is determined whether or not the hyperlink selection instruction corresponds uniquely to a hyperlink within the current page, and if so, an object of a hyperlink corresponding to the hyperlink selection instruction is shown on a newly-rendered browser page.

In particular, with the above alternative solution, the method for selecting a hyperlink can be compatible with the existing method. For example, when a user clicks a hyperlink, a page hopping can be performed according to the selected hyperlink, and when the user conducts a long sliding or pressing operation, a plurality of hyperlinks within a display region corresponding to the operation can be obtained and displayed in a zoomed-in page frame, so as to be selected by the user conveniently.

In step S103, a new page frame is rendered on the current page, and the page frame shows the candidate hyperlinks in a preset display ratio.

In the present embodiment, the page frame is a relevant control in which the current page can show hyperlinks. The preset display ratio is a zoomed-in display ratio based on the displaying of hyperlinks by the current page. Alternatively, the preset display ratio is 2. After obtaining all hyperlinks within a display region corresponding to the hyperlink selection instruction as candidate hyperlinks, the mobile terminal renders a new page frame on the current page, wherein the page frame is placed on the current page and the candidate hyperlinks are shown in a preset display ratio on the page frame. Since the candidate hyperlinks are displayed in a zoomed-in manner, it is more convenient for the user to confirm and select the required hyperlink.

In step S104, a required hyperlink is selected from the candidate hyperlinks on the page frame.

In the present embodiment, upon receiving a candidate hyperlink selection instruction from a user, the mobile terminal selects a required hyperlink from the candidate hyperlinks on the page frame. Selecting a required hyperlink from the candidate hyperlinks on the page frame comprises specifically the step of:

receiving a candidate hyperlink selection instruction on the page frame and selecting a candidate hyperlink corresponding to the candidate hyperlink selection instruction as a selected hyperlink, while closing the page frame and showing an object corresponding to the selected hyperlink on a newly-rendered browser page.

In an example, the candidate hyperlink selection instruction can include but not limited to an instruction of sliding to the left, an instruction of sliding to the right, an instruction of sliding upward and an instruction of sliding downward. The object can includes text, image, page, e-mail, anchor, multimedia, and other objects which can be linked via hyperlinks. After obtaining the selected hyperlink, the page frame is closed and the object corresponding to the hyperlink is shown on the newly-rendered browser page. Since the candidate hyperlinks are shown in the preset display ratio on the page frame, the user can see and select easily the required hyperlink, thereby reducing the mistaken operations effectively.

In another alternative embodiment, before the step S104, a page frame drag instruction can further be received, and the candidate hyperlinks displayed on the page frame can be updated with all hyperlinks corresponding to a current page within a current display region of the dragged page frame as candidate hyperlinks.

For example, in a case where the candidate hyperlinks shown in the page frame may be not required by the user, it is possible to obtain in real time hyperlinks within a display region of the page frame by dragging the display region of the page frame in the current page, and to update the candidate hyperlinks in the page frame, to enable to select a hyperlink more flexibly.

As an example, an applying situation of the present embodiment will be described as below with an android mobile phone as a specific targeting object.

In a case where a user is reading a novel in a novel reading page and the page is needed to hop to another one upon the user has finished the page, the user can press a long time a region near a hyperlink button of page hopping. Then, the phone can acquire a display region centered on the long-pressed point and with a preset distance as a radius, detect a plurality of hyperlinks in the display region as candidate hyperlinks, render a new page frame on the current novel reading page, magnify the candidate hyperlinks two times for example and display on the page frame. By magnifying the hyperlinks, the user can see more clearly the plurality of hyperlinks. In another example, when the required hyperlink by the user is not magnified, the page frame can be moved to a hyperlink display region needed to be selected. The mobile terminal can update and display the required hyperlink in a zoomed-in manner in the page frame and the required hyperlink can be selected through sliding to the left or the right. Then, the page frame is closed, and a page of a next, last or other chapter corresponding to the hyperlink is shown on a newly-rendered browser page.

As an example, a kind of exemplary codes for implementing the zoomed-in displaying in an android system can be as follows:

public LongTextEditBoxDialog
showLongTextEditBoxDialog(LongEditTextListener listener)
{

//obtain a long text editing and displaying window

mLongTextEditDlg = (LongTextEditBoxDialog)
AppEngine.getInstance( ).getWindowManager( ).getFunctionWindow(MttWindow.
WND_LONGTEXTEDIT);
//set Listener for editing

mLongTextEditDlg.setLongEditListener(listener);

//set Listener when the window quits

mLongTextEditDlg.setOnDismissListener(new OnDismissListener( ) {

@Override
public void onDismiss(DialogInterface dialog)
{

//call the display window when quitting

mLongTextEditDlg.onDismiss(dialog);
mLongTextEditDlg = null;

}

```
};
  //display the long text editing window
mLongTextEditDlg.showWindow( );
  //return to the text editing window
return mLongTextEditDlg;
}
```

Through displaying at least one hyperlink of the display region in a zoomed-in manner via a page frame, the present embodiment enables the user to select a hyperlink more accurately and conveniently, thereby improving the accuracy of selecting a hyperlink.

### Second Embodiment

FIG. 2 shows an exemplary structural diagram of an apparatus for selecting a hyperlink provided in a second embodiment of the invention. To explain conveniently, it shows only parts related to embodiments of the invention. In the present embodiment, the apparatus for selecting a hyperlink includes: an instruction detecting unit 21, a hyperlink obtaining unit 22, a hyperlink showing unit 23, a hyperlink selecting unit 24, a determining unit 25 and a hyperlink updating unit 26.

In particular, the instruction detecting unit 21 is configured to detect a hyperlink selection instruction on a current page.

The hyperlink obtaining unit 22 is configured to obtain all hyperlinks within a display region corresponding to the hyperlink selection instruction as candidate hyperlinks, if detecting the hyperlink selection instruction.

The hyperlink showing unit 23 is configured to render a new page frame on the current page, the page frame showing the candidate hyperlinks in a preset display ratio.

The hyperlink selecting unit 24 is configured to select a required hyperlink from the candidate hyperlinks on the page frame.

Further, the hyperlink obtaining unit 22 is configured to obtain all hyperlinks within a fixed display region centered on a coordinate point corresponding to the hyperlink selection instruction as the candidate hyperlinks.

In addition, the hyperlink selecting unit 24 is specifically configured to receive a candidate hyperlink selection instruction on the page frame and select a candidate hyperlink corresponding to the candidate hyperlink selection instruction as a selected hyperlink, while closing the page frame and showing an object corresponding to the selected hyperlink on a newly-rendered browser page.

In addition, the apparatus further includes a determining unit 25 configured to determine whether or not the hyperlink selection instruction corresponds uniquely to a hyperlink within the current page, and if so, show an object of a hyperlink corresponding to the hyperlink selection instruction on a newly-rendered browser page.

In addition, the apparatus further includes a hyperlink updating unit 26 configured to receive a page frame drag instruction, and update the candidate hyperlinks displayed on the page frame with hyperlinks corresponding to a current page within a current display region of the dragged page frame as candidate hyperlinks.

The apparatus for selecting a hyperlink provided in the present embodiment of the invention can be applied in the first method embodiment as described above. The above description of the first embodiment can be referred to for details and is omitted herein.

It should be noted that, in above system embodiment, respective units included are partitioned merely according to functional logics, but are not limited to this kind of partition, as long as the units can implement corresponding functions. In addition, the names of various functional units are merely for distinguishing between each other conveniently, but do not intent to limit the scope of the invention.

In addition, it should be understood by those skilled in the art that, all or part of steps in the above method of various embodiments can be implemented by related hardware instructed by a program. The program can be stored on a computer readable storage medium such as ROM/RAM, magnetic disk or optical disk and the like.

The above descriptions are merely preferred embodiments of the present invention and do not intend to limit the invention. Any modifications, alternations or improvements made without departing from the spirit and principle of the present invention should fall within the protection scope of the present invention.

What is claimed is:

1. A method for selecting hyperlinks, the method comprising the steps of:
detecting a hyperlink selection instruction on a current page;
obtaining all hyperlinks within a display region corresponding to the hyperlink selection instruction as candidate hyperlinks, if detecting the hyperlink selection instruction;
rendering a new page frame on the current page, the page frame showing the candidate hyperlinks in a preset display ratio; and
selecting a required hyperlink from the candidate hyperlinks on the page frame.

2. The method according to claim 1, wherein the step of obtaining all hyperlinks within a display region corresponding to the hyperlink selection instruction as candidate hyperlinks comprises the step of:
obtaining all hyperlinks within a fixed display region centered on a coordinate point corresponding to the hyperlink selection instruction as the candidate hyperlinks.

3. The method according to claim 1, wherein the step of selecting a required hyperlink from the candidate hyperlinks on the page frame comprises the step of:
receiving a candidate hyperlink selection instruction on the page frame and selecting a candidate hyperlink corresponding to the candidate hyperlink selection instruction as a selected hyperlink, while closing the page frame and showing an object corresponding to the selected hyperlink on a newly-rendered browser page.

4. The method according to claim 1, wherein before the step of obtaining all hyperlinks within a display region corresponding to the hyperlink selection instruction as candidate hyperlinks, the method further comprises:
determining whether or not the hyperlink selection instruction corresponds uniquely to a hyperlink within the current page, and if so, showing an object of a hyperlink corresponding to the hyperlink selection instruction on a newly-rendered browser page.

5. The method according to claim 1, wherein before the step of selecting a required hyperlink from the candidate hyperlinks on the page frame, the method further comprises:
receiving a page frame drag instruction, and updating the candidate hyperlinks displayed on the page frame with all hyperlinks corresponding to a current page within a current display region of the dragged page frame as candidate hyperlinks.

6. An apparatus for selecting hyperlinks, the apparatus comprising:
an instruction detecting unit configured to detect a hyperlink selection instruction on a current page;
a hyperlink obtaining unit configured to obtain all hyperlinks within a display region corresponding to the hyperlink selection instruction as candidate hyperlinks, if detecting the hyperlink selection instruction;
a hyperlink showing unit configured to render a new page frame on the current page, the page frame showing the candidate hyperlinks in a preset display ratio; and
a hyperlink selecting unit configured to select a required hyperlink from the candidate hyperlinks on the page frame.

7. The apparatus according to claim 6, wherein the hyperlink obtaining unit is configured to obtain all hyperlinks within a fixed display region centered on a coordinate point corresponding to the hyperlink selection instructions the candidate hyperlinks.

8. The apparatus according to claim 6, wherein the hyperlink selecting unit is configured to receive a candidate hyperlink selection instruction on the page frame and select a candidate hyperlink corresponding to the candidate hyperlink selection instruction as a selected hyperlink, while closing the page frame and showing an object corresponding to the selected hyperlink on a newly-rendered browser page.

9. The apparatus according to claim 6, wherein the apparatus further comprises:
a determining unit configured to determine whether or not the hyperlink selection instruction corresponds uniquely to a hyperlink within the current page, and if so, show an object of a hyperlink corresponding to the hyperlink selection instruction on a newly-rendered browser page.

10. The apparatus according to claim 6, wherein the apparatus further comprises:
a hyperlink updating unit configured to receive a page frame drag instruction, and update the candidate hyperlinks displayed on the page frame with hyperlinks corresponding to a current page within a current display region of the dragged page frame as candidate hyperlinks.

11. A computer readable storage medium storing the computer executable instructions, when executed, which cause a processor to perform the operations of:
detecting a hyperlink selection instruction on a current page;
obtaining all hyperlinks within a display region corresponding to the hyperlink selection instruction as candidate hyperlinks, if detecting the hyperlink selection instruction;
rendering a new page frame on the current page, the page frame showing the candidate hyperlinks in a preset display ratio; and
selecting a required hyperlink from the candidate hyperlinks on the page frame.

12. The computer readable storage medium according to claim 11, wherein the instruction for performing the operation of obtaining all hyperlinks within a display region corresponding to the hyperlink selection instruction as candidate hyperlinks comprises the instruction for performing the following operation of:
obtaining all hyperlinks within a fixed display region centered on a coordinate point corresponding to the hyperlink selection instruction as the candidate hyperlinks.

13. The computer readable storage medium according to claim 11, wherein the instruction for performing the operation of selecting a required hyperlink from the candidate hyperlinks on the page frame comprises the instruction for performing the following operation of:
receiving a candidate hyperlink selection instruction on the page frame and selecting a candidate hyperlink corresponding to the candidate hyperlink selection instruction as a selected hyperlink, while closing the page frame and showing an object corresponding to the selected hyperlink on a newly-rendered browser page.

14. The computer readable storage medium according to claim 11, further comprising the instruction for performing the following operation of: before obtaining all hyperlinks within a display region corresponding to the hyperlink selection instruction as candidate hyperlinks, determining whether or not the hyperlink selection instruction corresponds uniquely to a hyperlink within the current page, and if so, showing an object of a hyperlink corresponding to the hyperlink selection instruction on a newly-rendered browser page.

15. The computer readable storage medium according to claim 11, further comprising the instruction for performing the following operation of: before selecting a required hyperlink from the candidate hyperlinks on the page frame, receiving a page frame drag instruction, and updating the candidate hyperlinks displayed on the page frame with all hyperlinks corresponding to a current page within a current display region of the dragged page frame as candidate hyperlinks.
